(19) United States
(12) Patent Application Publication
(10) Pub. No.: US 2026/0296907 A1
(43) Pub. Date: Oct. 1, 2026

(54) HIGH-EFFICIENCY METHOD FOR PRODUCING LITHIUM HYDROXIDE FROM LITHIUM CARBONATE THROUGH PROCESS IMPROVEMENT

(71) Applicant: Korea Institute Of Geoscience And Mineral Resources, Daejeon (KR)

(72) Inventors: Tae-Gong RYU, Daejeon (KR); Jun-Ho SHIN, Daejeon (KR); Jae-Min JEONG, Sejong-si (KR)

(73) Assignee: Korea Institute Of Geoscience And Mineral Resources, Daejeon (KR)

(21) Appl. No.: 19/474,911

(22) PCT Filed: Apr. 5, 2024
(86) PCT No.: PCT/KR2024/004472

§ 371 Date: Oct. 13, 2025

(30) Foreign Application Priority Data
Apr. 13, 2023 (KR) 10-2023-0048654

(51) Int. Cl. C01D 15/02; B01D 9/00; B01D 61/42; C01D 1/22; C01D 1/30; C01D 1/42

(52) U.S. Cl. CPC C01D 15/02; B01D 9/0031; B01D 61/428; C01D 1/22; C01D 1/30; C01D 1/42; C01P 2002/72; C01P 2006/80

(57) ABSTRACT

The present invention relates to a method for producing lithium hydroxide (LiOH) with high efficiency from lithium carbonate (Li₂CO₃) through process improvement, whereby lithium hydroxide can be produced from lithium carbonate with high efficiency in an environmentally friendly manner by improving the final lithium ion concentration and the lithium ion recovery rate and reusing wastes.

### TECHNICAL FIELD

The present disclosure relates to a method for producing lithium hydroxide with high efficiency from lithium carbonate through process improvement.

### BACKGROUND ART

Conventional methods for converting lithium compounds such as lithium sulfate (Li₂SO₄), lithium chloride (LiCl), and lithium carbonate (Li₂CO₃) into lithium hydroxide (LiOH) have been proposed, and the conversion methods differ depending on the type of lithium compound, resulting in different conversion efficiencies and recovery rates.

Among the methods of converting lithium sulfate (Li₂SO₄) into lithium hydroxide (LiOH), a method is used in which a lithium sulfate (Li₂SO₄) solution, which is an intermediate recovered in a recent process for recycling waste lithium secondary batteries, is mixed with caustic soda, and sodium sulfate (Na₂SO₄) as a by-product is precipitated and separated through a soda cooling method to recover a lithium hydroxide solution. However, in the case of sodium sulfate (Na₂SO₄) generated as a by-product, there is a problem of relatively high environmental burden due to wastewater treatment or waste landfill.

In addition, as a method of converting lithium chloride (LiCl) into lithium hydroxide (LiOH), a method has been proposed in which lithium chloride (LiCl) is used as a raw material through a bipolar electrodialysis process to separate a lithium hydroxide (LiOH) solution and a hydrochloric acid (HCl) solution. However, the separation efficiency is relatively low, and the membrane material, which is a component of the electrodialysis system, has low alkali resistance, thereby causing a maintenance burden.

Accordingly, a method of converting lithium carbonate (Li₂CO₃) into lithium hydroxide (LiOH) is generally applied.

In the conventional method of converting lithium carbonate (Li₂CO₃) into lithium hydroxide (LiOH), calcium carbonate (CaCO₃) generated is discharged in the form of a cake, and due to its moisture content, the lithium hydroxide solution content is high, thereby causing a problem of lithium hydroxide solution loss if it is not reused.

### DISCLOSURE

### Technical Problem

The present disclosure has an object to provide a method for producing lithium hydroxide with a high recovery rate from lithium carbonate.

Another object of the present disclosure is to reduce the amount of wastewater generated in the process of producing lithium hydroxide from lithium carbonate by recycling sludge generated in the process.

Still another object of the present disclosure is to reduce the amount of wastewater generated in the process of producing lithium hydroxide from lithium carbonate by recycling steam generated in the process.

Yet another object of the present disclosure is to provide a manufacturing method for selecting a crystalline form of lithium hydroxide by controlling pressure and temperature conditions during crystallization.

### Technical Solution

In order to solve the conventional problems as described above, an aspect of the present disclosure provides a method for producing lithium hydroxide, comprising:
(a) preparing a mixture by adding calcium hydroxide (Ca(OH)₂) to a lithium carbonate (Li₂CO₃) slurry;
(b) separating a filtrate from the mixture prepared in step (a);
(c) concentrating the filtrate separated in step (b); and
(d) crystallizing lithium hydroxide (LiOH) from the filtrate concentrated in step (c).

In some exemplary embodiments, in step (a), the lithium carbonate slurry may be prepared by mixing lithium carbonate (Li₂CO₃) with an aqueous solution at a solid-to-liquid ratio of 40 to 80 (g/L), and
in step (a), a molar ratio of hydroxide ions (OH−) to lithium ions (Li+) in the mixture may range from 1:1 to 1.5:1.

In some exemplary embodiments, the step (a) may be performed at a temperature of 20° C. to 100° C. for at least 1 hour.

In some exemplary embodiments, the method for producing lithium hydroxide may further comprise:
(b-1) subjecting sludge remaining after the separation of the filtrate in step (b) to water washing with stirring;
(b-2) separating a solution obtained after the water washing of the sludge in step (b-1) and preparing a concentrated lithium ion aqueous solution through an electric adsorption process; and
(b-3) feeding the concentrated lithium ion aqueous solution obtained in step (b-2) into the mixture of step (a).

In some exemplary embodiments, the electric adsorption process may be a membrane capacitive deionization (MCDI) process.

In some exemplary embodiments, the electric adsorption process of step (c-1) may be repeated.

In some exemplary embodiments, a desalted solution generated through the electric adsorption process may be fed into the water washing of the sludge for use.

In some exemplary embodiments, when a calcium compound is precipitated through the concentration of step (c), the precipitated calcium compound may be removed from the filtrate to increase purity of lithium hydroxide (LiOH).

In some exemplary embodiments, when lithium hydroxide and a calcium compound are precipitated through the concentration of step (c), the calcium compound may be removed from a solution of the lithium hydroxide and the calcium compound that are precipitated, and an aqueous solution of the lithium hydroxide may be fed into the mixture of step (a).

In some exemplary embodiments, the crystallization of lithium hydroxide (LiOH) performed in step (d) may be carried out by evaporating the filtrate.

In some exemplary embodiments, the crystallization of lithium hydroxide (LiOH) performed in step (d) may be carried out at a pressure of 20 to 50 mbar and at a temperature of 40° C. or lower.

In some exemplary embodiments, the crystallization of lithium hydroxide (LiOH) performed in step (d) may be carried out at a pressure of 20 to 50 mbar and at a temperature of 50° C. or higher.

In some exemplary embodiments, a solution obtained by condensing steam generated by the evaporation of step (d) may be fed into the water washing of the sludge for use.

### Advantageous Effects

The high-efficiency method for producing lithium hydroxide from lithium carbonate according to the present disclosure has the effect of improving the recovery rate of lithium hydroxide.

The high-efficiency method for producing lithium hydroxide from lithium carbonate according to the present disclosure has the effect of reducing the calcium ion concentration of the final product.

The high-efficiency method for producing lithium hydroxide from lithium carbonate according to the present disclosure has the effect of recycling waste sludge and wastewater generated by the reaction of lithium carbonate and calcium hydroxide.

The high-efficiency method for producing lithium hydroxide from lithium carbonate according to the present disclosure has the effect of reducing the amount of wastewater generated in the process of producing lithium hydroxide from lithium carbonate by recycling steam generated in the process.

### DESCRIPTION OF DRAWINGS

FIG. 1 is a process diagram illustrating a method for producing lithium hydroxide from lithium carbonate according to an exemplary embodiment of the present disclosure.

FIG. 2 is a graph comparing the thermodynamic stability of each lithium hydroxide (LiOH) conversion reaction when lithium carbonate (Li₂CO₃) reacts with hydroxides of group II alkaline earth metals according to an exemplary embodiment of the present disclosure.

FIG. 3 is a graph showing the distribution of the final lithium ion (Li⁺) concentration contained in the filtrate after the reaction of a mixture of lithium carbonate (Li₂CO₃) and calcium hydroxide (Ca(OH)₂) depending on the reaction temperature according to an exemplary embodiment of the present disclosure.

FIG. 4 is a graph showing the distribution of the final lithium ion (Li⁺) concentration contained in the filtrate depending on the solid-to-liquid ratio of lithium carbonate (Li₂CO₃) slurry and the OH−/Li⁺ molar ratio of a mixture of lithium carbonate (Li₂CO₃) and calcium hydroxide (Ca(OH)₂) according to an exemplary embodiment of the present disclosure.

FIG. 5 is a graph showing the recovery rate (%) of lithium hydroxide (LiOH) depending on the solid-to-liquid ratio of lithium carbonate (Li₂CO₃) slurry and the OH⁻/Li⁺ molar ratio of a mixture of lithium carbonate (Li₂CO₃) and calcium hydroxide (Ca(OH)₂) according to an exemplary embodiment of the present disclosure.

FIG. 6 is a graph showing the distribution of the final lithium ion (Li⁺) concentration contained in the filtrate after the reaction of a mixture of lithium carbonate (Li₂CO₃) and calcium hydroxide (Ca(OH)₂) depending on the reaction temperature according to an exemplary embodiment of the present disclosure (solid-to-liquid ratio of lithium carbonate (Li₂CO₃) slurry: 108.4, OH⁻/Li⁺ molar ratio of the mixture of lithium carbonate (Li₂CO₃) and calcium hydroxide (Ca(OH)₂):2).

FIG. 7 is a graph showing the recovery rate of lithium hydroxide (LiOH) after the reaction of a mixture of lithium carbonate (Li₂CO₃) and calcium hydroxide (Ca(OH)₂) depending on the reaction temperature according to an exemplary embodiment of the present disclosure (solid-to-liquid ratio of lithium carbonate (Li₂CO₃) slurry: 108.4, OH⁻/Li⁺ molar ratio of the mixture of lithium carbonate (Li₂CO₃) and calcium hydroxide (Ca(OH)₂):2).

FIG. 8 is a graph showing the concentration and recovery rate (%) of the final lithium ion (Li⁺) contained in the filtrate after the reaction depending on the solid-to-liquid ratio of lithium carbonate (Li₂CO₃) slurry, when a mixture of lithium carbonate (Li₂CO₃) and calcium hydroxide (Ca(OH)₂) is mixed using a homogenizer, according to an exemplary embodiment of the present disclosure.

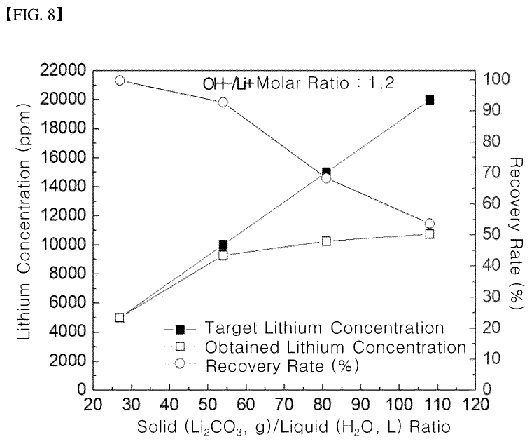

FIG. 9 is a graph showing the concentration and recovery rate (%) of the final lithium ion (Li⁺) contained in the filtrate depending on the number of hydroxylation reaction repetitions, when a mixture of lithium carbonate (Li₂CO₃) and calcium hydroxide (Ca(OH)₂) is repeatedly added to the separated filtrate after the reaction and mixed using a homogenizer, according to an exemplary embodiment of the present disclosure (solid-to-liquid ratio of lithium carbonate (Li₂CO₃) slurry: 27, OH⁻/Li⁺ molar ratio of the mixture of lithium carbonate (Li₂CO₃) and calcium hydroxide (Ca(OH)₂):1.2).

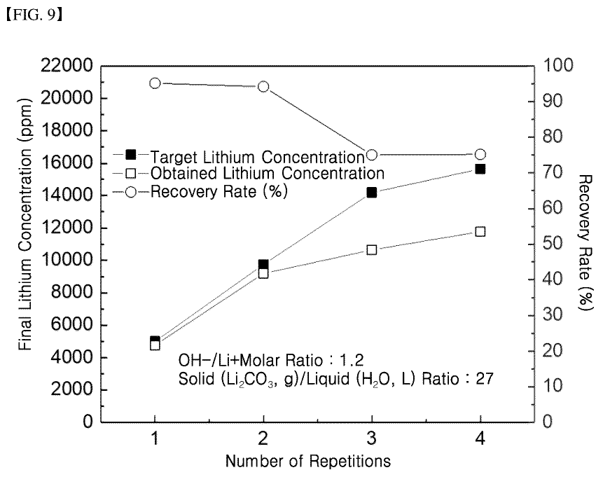

FIG. 10 is a graph showing the separated and concentrated lithium ion (Li⁺) concentration after repeatedly applying an electric adsorption process to the solution separated from the washing process of sludge discharged after the hydroxylation reaction of a mixture of lithium carbonate (Li₂CO₃) and calcium hydroxide (Ca(OH)₂) according to an exemplary embodiment of the present disclosure.

FIG. 11 is a graph showing the XRD pattern of the final product depending on the crystallization conditions of the filtrate after the hydroxylation reaction of a mixture of lithium carbonate (Li₂CO₃) and calcium hydroxide (Ca(OH)₂) according to an exemplary embodiment of the present disclosure (solid-to-liquid ratio of lithium carbonate (Li₂CO₃) slurry:60, reaction time: 3 to 8 hours, reaction temperature: 40 to 80° C., pressure condition: 37 mbar).

FIG. 12 is a graph showing the XRD pattern of the final product depending on the crystallization temperature of the filtrate after the hydroxylation reaction of a mixture of lithium carbonate (Li₂CO₃) and calcium hydroxide (Ca(OH)₂) according to another exemplary embodiment of the present disclosure (solid-to-liquid ratio of lithium carbonate (Li₂CO₃) slurry: 60, reaction time: 3 hours, reaction temperature: 80° C., pressure condition: 37 mbar).

FIG. 13 is a graph showing the XRD pattern of the final product depending on the crystallization temperature of the filtrate after the hydroxylation reaction of a mixture of lithium carbonate (Li₂CO₃) and calcium hydroxide (Ca(OH)₂) according to still another exemplary embodiment of the present disclosure (solid-to-liquid ratio of lithium carbonate (Li₂CO₃) slurry: 60, reaction time: 8 hours, reaction temperature: 40° C., pressure condition: 37 mbar).

FIG. 14 is a graph showing the distribution of lithium ion (Li⁺) content contained in the filtrate depending on the concentration rate of a lithium hydroxide (LiOH) solution according to an exemplary embodiment of the present disclosure.

FIG. 15 is a graph showing the distribution of calcium (Ca²⁺) ion content contained in the filtrate depending on the concentration rate of a lithium hydroxide (LiOH) solution according to an exemplary embodiment of the present disclosure.

### BEST MODE

The present disclosure has an object of providing a method for producing lithium hydroxide with a high recovery rate from lithium carbonate.

Another object of the present disclosure is to reduce the amount of wastewater generated in the process of producing lithium hydroxide from lithium carbonate by recycling sludge generated during the process.

Still another object of the present disclosure is to reduce the amount of wastewater generated in the process of producing lithium hydroxide from lithium carbonate by recycling steam generated during the process.

Yet another object of the present disclosure is to provide a manufacturing method for selecting the crystalline form of lithium hydroxide by controlling pressure and temperature conditions during crystallization.

### MODE FOR INVENTION

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

Method for Producing Lithium Hydroxide from Lithium Carbonate

The present disclosure provides a method for producing lithium hydroxide, comprising:
(a) preparing a mixture by adding calcium hydroxide (Ca(OH)₂) to a lithium carbonate (Li₂CO₃) slurry;
(b) separating a filtrate from the mixture prepared in step (a);
(c) concentrating the filtrate separated in step (b); and
(d) crystallizing lithium hydroxide (LiOH) from the filtrate concentrated in step (c).
   (a) Preparing a Mixture by Adding Calcium Hydroxide (Ca(OH)₂) to a Lithium Carbonate (Li₂CO₃) slurry;

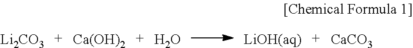

Lithium carbonate (Li₂CO₃) may be reacted with calcium hydroxide (Ca(OH)₂) according to Chemical Formula 1 to produce lithium hydroxide.

At this time, it is preferable that lithium carbonate (Li₂CO₃) is added to an aqueous solution and used in the form of a lithium carbonate (Li₂CO₃) slurry. The aqueous solution may include water, distilled water, purified water, and the like, but is not limited thereto, and a solution conventionally used in the technical field of the present disclosure may be employed.

The term “slurry” refers to a suspension in which fine solid particles are suspended in an aqueous solution or to a mixture of a solid and a liquid. That is, when the amount of solid is below the solubility value, the solid exists in the state of an aqueous solution, and when the amount of solid exceeds the solubility value, the solid exists as a powder mixed in the solution.

The term “sludge” refers to a precipitate obtained when a suspension after a reaction is subjected to solid-liquid separation. That is, it means a solid material such as a cake generated during a wet conversion reaction.

When the hydroxylation reaction is performed with lithium carbonate in the form of a slurry, the mixing uniformity is increased, thereby improving the reaction rate and reaction efficiency, and after separating the filtrate from the hydroxylation reaction of lithium carbonate (Li₂CO₃), unreacted lithium carbonate contained in the residual sludge can be additionally reacted and subjected to water washing to recover lithium hydroxide, while reducing the treatment burden of calcium carbonate having strong alkalinity and reducing the amount of wastewater.

In the hydroxylation reaction process of lithium carbonate (Li₂CO₃), alkaline earth metal hydroxides, for example Ca(OH)₂, Sr(OH)₂, Ba(OH)₂, or Ra(OH)₂, may be used.

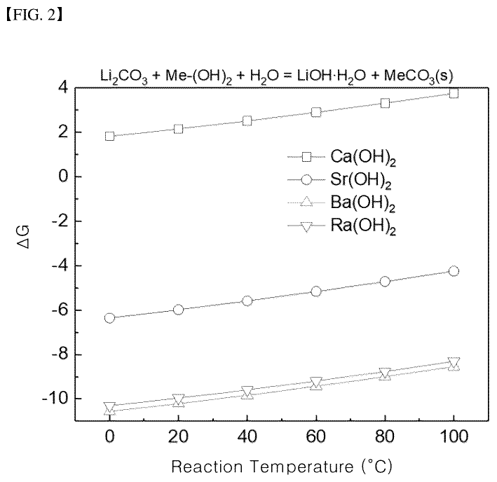

Among the alkaline earth metal hydroxides (for example, Ca(OH)₂, Sr(OH)₂, Ba(OH)₂, Ra(OH)₂), calcium hydroxide (Ca(OH)₂) has the lowest thermodynamic reaction stability, which means that the conversion efficiency of the hydroxylation reaction is low (see FIG. 2).

However, calcium hydroxide (Ca(OH)₂) has an economic advantage compared to other alkaline earth metal hydroxides, and therefore a method for producing lithium hydroxide that increases the final lithium ion concentration and lithium ion recovery rate has been developed by reacting lithium carbonate with calcium hydroxide (Ca(OH)₂).

In step (a), the lithium carbonate (Li₂CO₃) slurry may be prepared by mixing lithium carbonate (Li₂CO₃) with an aqueous solution at a solid-to-liquid ratio of 40 to 80 (g/L), and in step (a), the molar ratio of hydroxide ions (OH⁻) to lithium ions (Li⁺) in the mixture may be 1:1 to 1.5:1.

Within the ranges of the above solid-to-liquid ratio and the molar ratio of hydroxide ions (OH⁻) to lithium ions (Li⁺), the recovery rate of lithium ions is as high as 80% or more.

Step (a) may be performed at 20° C. to 100° C. for at least 1 hour.

It was confirmed that as the reaction temperature increased during the hydroxylation reaction of lithium carbonate, the final lithium ion concentration and the recovery rate of lithium ions increased, and the time required to reach chemical equilibrium decreased.

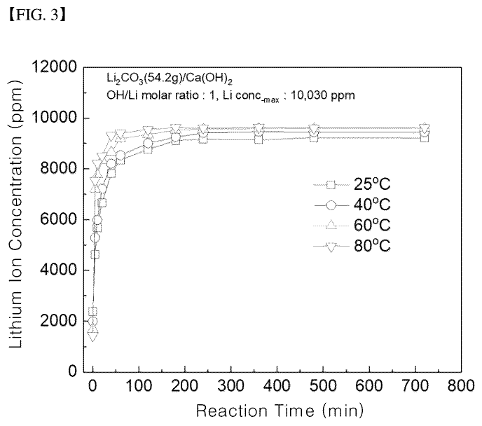

When the step of adding calcium hydroxide (Ca(OH)₂) to the lithium carbonate (Li₂CO₃) slurry and mixing is carried out at less than 20° C., there is a problem in that the final lithium ion concentration and the recovery rate of lithium ions decrease and the time required to reach chemical equilibrium increases. On the other hand, when the step of adding calcium hydroxide (Ca(OH)₂) to the lithium carbonate (Li₂CO₃) slurry and mixing is carried out at more than 100° C., there is a problem in that a large amount of energy is consumed for the hydroxylation reaction of the lithium carbonate slurry. When the mixing time is less than 1 hour, there is a problem in that the chemical equilibrium is not reached and the final lithium ion concentration and recovery rate are low (see Table 1 and FIG. 3).

The mixture of step (a) may be stirred to obtain a lithium hydroxide solution. Preferably, the mixture may be stirred at 5,000 to 9,000 rpm.

Referring to Table 3 and Table 9 below, when a homogenizer at 5,000 to 9,000 rpm is used to stir the mixture at high speed, the lithium ion recovery rate can increase.

(b) Separating a Filtrate from the Prepared Mixture

In step (b), a filtrate is separated from the mixture generated through the hydroxylation reaction of step (a), and sludge is discharged.

Regarding the sludge, step (b) may further include:
(b-1) washing the sludge remaining after the separation of the filtrate in step (b) with stirring;
(b-2) separating a solution obtained after the water washing of the sludge in step (b-1) and preparing a concentrated lithium ion aqueous solution through an electric adsorption process; and
(b-3) feeding the concentrated lithium ion aqueous solution obtained in step (b-2) into the mixture of step (a).

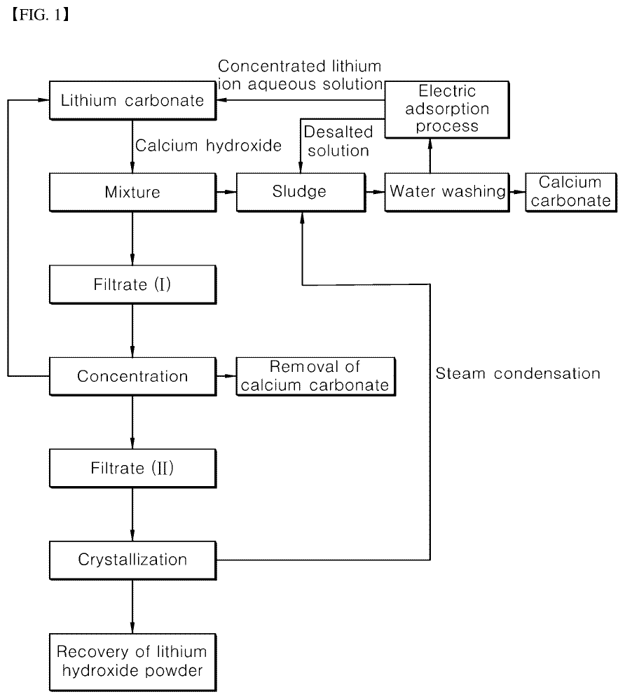

Through step (b-1), the hydroxylation reaction of unreacted lithium carbonate (Li₂CO₃) may be carried out, and due to the moisture content of calcium carbonate (CaCO₃), a lithium hydroxide (LiOH) solution adhered or adsorbed to the surface of calcium carbonate (CaCO₃) may be separated therefrom to obtain a low-concentration lithium hydroxide aqueous solution. Referring to Example 7 below, it was confirmed that the lithium ion solution obtained through water washing can be recycled for preparing a lithium carbonate (Li₂CO₃) slurry (see FIG. 1).

The lithium ion concentration of the lithium hydroxide solution obtained by washing sludge through the electric adsorption process may be increased. When the lithium ion concentration of the lithium hydroxide solution obtained by washing sludge through the electric adsorption process is increased and the solution is used as an aqueous solution for preparing a subsequent lithium carbonate (Li₂CO₃) slurry, there is an effect of further increasing the recovery rate of lithium ions.

The electric adsorption process may be a membrane capacitive deionization (MCDI) process.

The MCDI (membrane capacitive deionization) process is one of the electric adsorption processes in which an anion exchange membrane and a cation exchange membrane are combined with electrodes composed of carbon material so that ions selectively pass through and are adsorbed and desorbed on the electrodes. When the MCDI process is used as the electric adsorption process, the recovery rate of ions can increase, and regeneration and maintenance may be easy.

The electric adsorption process may be repeated.

By repeatedly performing the electric adsorption process, a more concentrated lithium ion aqueous solution may be prepared, and the more concentrated lithium ion aqueous solution may be fed into the mixture of step (a) to increase the lithium ion recovery rate.

In addition, a filtrate generated through the electric adsorption process may be fed into the sludge water washing. Preferably, the filtrate may be used for the water washing of the sludge in step (b-1).

When the filtrate generated during the electric adsorption process is reused by being fed into the sludge water washing, the amount of wastewater generated in the process can be reduced, and lithium hydroxide can be produced in an environmentally friendly manner.

### (c) Concentrating the Separated Filtrate

Step (c) is a process of increasing the concentration of lithium hydroxide in the filtrate separated in step (b), which may be carried out by evaporating water from the filtrate. The evaporation may be performed under reduced pressure.

When a calcium compound is precipitated through the concentration of step (c), the precipitated calcium compound may be removed from the filtrate to increase the purity of lithium hydroxide (LiOH) in the filtrate. Preferably, the removal of the calcium compound may be carried out by filtering the calcium compound from the filtrate. The calcium compound may be calcium carbonate (CaCO₃) or calcium hydroxide (Ca(OH)₂).

When the amount of calcium contained in the concentrate through step (c) exceeds the solubility of calcium, it may be precipitated as calcium carbonate (CaCO₃).

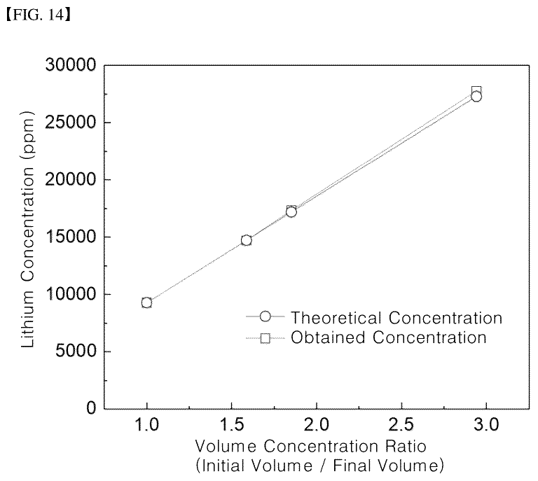

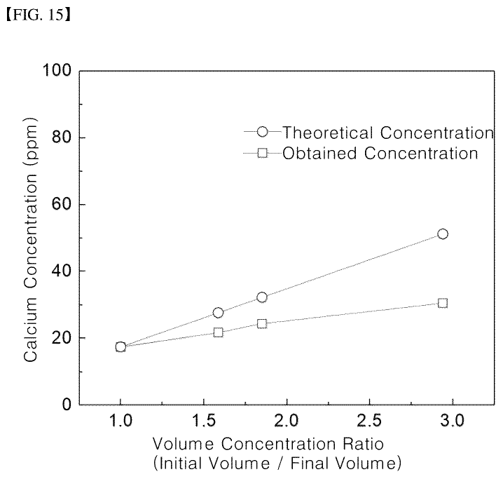

For example, the solubility of calcium carbonate (CaCO₃) is about 0.013 g/L at 25° C., while the solubility of lithium hydroxide (LiOH) is about 128 g/L at 20° C. Accordingly, it can be seen that the solubility of calcium carbonate (CaCO₃) is much lower than that of lithium hydroxide (LiOH) under similar temperature conditions. Therefore, as the filtrate is concentrated, the concentration of calcium carbonate (CaCO₃) increases and the amount of precipitated calcium carbonate increases. By removing the precipitated calcium carbonate, the concentration of lithium hydroxide (LiOH) in the filtrate may be increased to improve the purity of lithium hydroxide (LiOH) (see FIGS. 14 and 15).

When carbonate ions (CO₃²⁻) remain in the filtrate, calcium carbonate is precipitated during the concentration process. When carbonate ions (CO₃²⁻) are absent in the filtrate, the filtrate becomes strongly alkaline, so calcium ions (Ca²⁺) may react with hydroxide ions (OH⁻) to be precipitated as calcium hydroxide (Ca(OH)₂).

In addition, when lithium hydroxide and a calcium compound are precipitated through the concentration of step (c), the calcium compound may be removed from a solution of the precipitated lithium hydroxide and calcium compound, and the lithium hydroxide aqueous solution may be fed into the mixture of step (a). Preferably, the removal of the calcium compound may be carried out by filtering the calcium compound from the solution of lithium hydroxide and the calcium compound. The aqueous solution may include water, distilled water, purified water, and the like, but is not limited thereto, and a solution conventionally used in the technical field of the present disclosure may be employed.

When the amount of lithium hydroxide contained in the concentrate through step (c) exceeds the solubility of lithium hydroxide, not only calcium compounds but also lithium hydroxide (LiOH) may be precipitated.

When both calcium compounds and lithium hydroxide (LiOH) are precipitated during the concentration process of the filtrate, and the precipitated lithium hydroxide (LiOH) and calcium compounds are mixed into an aqueous solution, the calcium compound remains as a solid because its solubility is lower than that of lithium hydroxide (LiOH). Therefore, the calcium compound existing as a solid can be easily filtered.

After filtering the calcium compound, the residual lithium hydroxide aqueous solution may be fed into the mixture of step (a) to effectively reuse the precipitated lithium hydroxide (LiOH), thereby improving the purity of lithium hydroxide (LiOH) (see Table 13).

(d) Crystallizing Lithium Hydroxide (LiOH) from the Concentrated Filtrate

In step (d), lithium hydroxide is crystallized from the filtrate concentrated in step (c). Crystallization refers to forming crystals of a substance from a liquid or solution. The crystallization of lithium hydroxide (LiOH) provided by the present disclosure may be carried out by evaporating the filtrate.

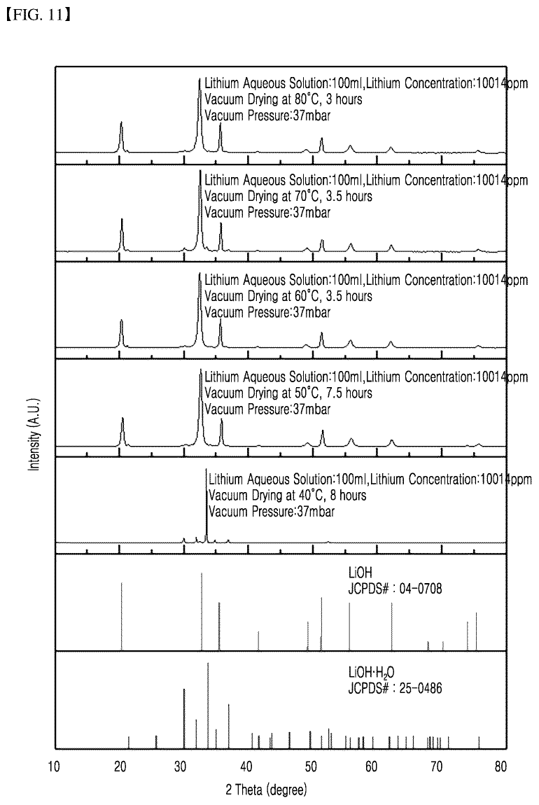

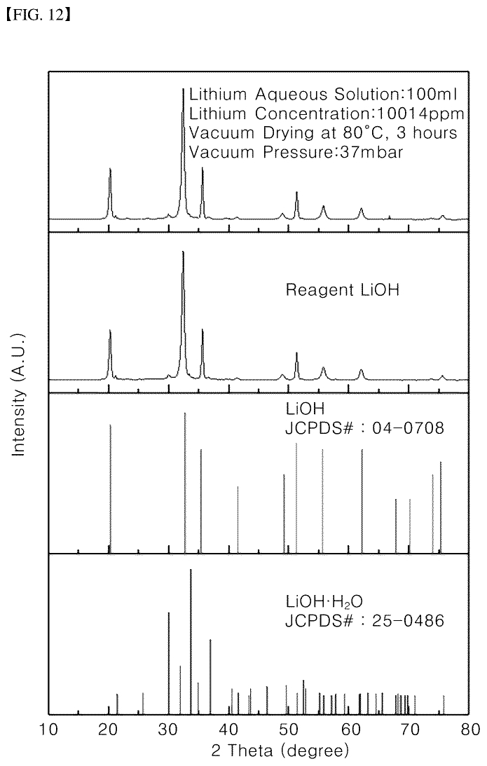

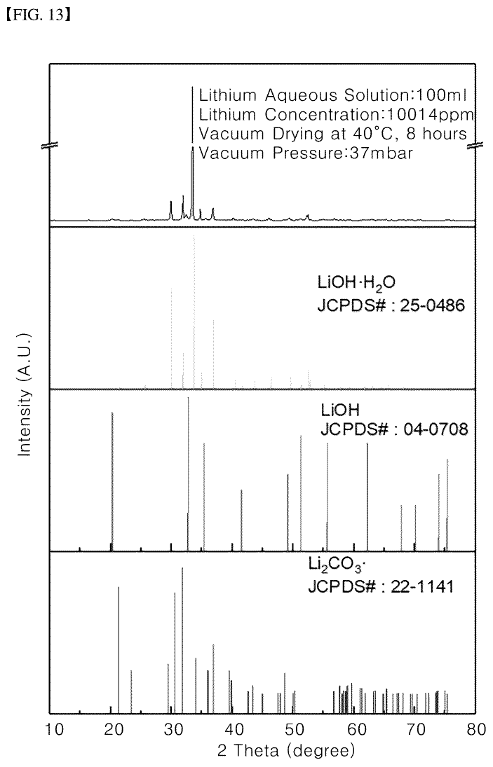

FIGS. 11 to 13 show XRD patterns of lithium hydroxide crystallized by evaporating an aqueous solution at a temperature of 40° C. to 80° C. under a reduced pressure condition of 37 mbar.

At a temperature of 50° C. or higher under a reduced pressure condition of 37 mbar, lithium hydroxide anhydrate was observed. Lithium hydroxide anhydrate means lithium hydroxide not combined with a water molecule.

At a temperature of 40° C. under a reduced pressure condition of 37 mbar, lithium hydroxide monohydrate was observed. Lithium hydroxide monohydrate means lithium hydroxide combined with one water molecule.

A solution obtained by condensing steam generated by the evaporation may be fed into the sludge water washing. Preferably, it may be used for the water washing of the sludge in step (b-1).

By cooling the steam generated through evaporation and using it in the sludge water washing process, the process water and wastewater used in the process can be reduced, and lithium hydroxide can be produced in an environmentally friendly manner.

### Exemplary Embodiments

Hereinafter, exemplary embodiments will be described in detail to specifically explain the present disclosure. However, the exemplary embodiments according to the present disclosure may be modified in various forms, and the scope of the present disclosure should not be construed as being limited to the embodiments described below. The exemplary embodiments of the present disclosure are provided to more fully explain the present disclosure to those of ordinary skill in the art.

### Experimental Example 1: Reaction Rate and Lithium Recovery According to Reaction Temperature in the Hydroxylation of Lithium Carbonate

In the hydroxylation of lithium carbonate (Li₂CO₃) using calcium hydroxide (Ca(OH)₂), the concentration of lithium ions in the filtrate was analyzed according to the reaction temperature (see FIG. 3).

First, 54.2 g of lithium carbonate (Li₂CO₃) powder (purity: 98.5%) was mixed with 1 L of distilled water (H₂O), and then 56.07 g of calcium hydroxide (Ca(OH)₂) powder (purity: 95%) was added to achieve a molar ratio of OH⁻/Li⁺ of 1. The mixture was reacted for 12 hours under stirring conditions of 300 RPM using a mechanical stirrer.

Second, in order to suppress losses and concentration changes in the solution due to evaporation caused by increased temperature during the hydroxylation reaction of lithium carbonate (Li₂CO₃), a reflux reactor equipped with a condenser was used. The condenser allowed for the recirculation of the vaporized solution by condensing it back into liquid form through circulating cooling water. In addition, temperature-controlled heating water was supplied into the inner space of a double-jacketed reactor to control the internal temperature of the reactor.

Table 1 shows the analysis results of the conversion efficiency of the hydroxylation reaction of lithium carbonate (Li₂CO₃) at different reaction temperatures.

TABLE 1

| | | 25° C. | | 40° C. | | 60° C. | | 80° C. | |
|---|---|---|---|---|---|---|---|---|---|
| | | Analysis | | Analysis | | Analysis | | Analysis | |
| | Reaction | Concen- | Recovery | Concen- | Recovery | Concen- | Recovery | Concen- | Recovery |
| | Time | tration | Rate | tration | Rate | tration | Rate | tration | Rate |
| Sample | (min) | (ppm) | (%) | (ppm) | (%) | (ppm) | (%) | (ppm) | (%) |
| Li₂CO₃: 54.20 g/1 L | Initial | 2388 | | 1998 | | 1698 | | 1438 | |
| H₂O | 5 | 4638 | 46.2 | 5292 | 52.8 | 7212 | 71.9 | 7548 | 75.3 |
| Ca(OH)₂: 56.07 g | 10 | 5682 | 56.6 | 5988 | 59.7 | 7764 | 77.4 | 8226 | 82.0 |
| (OH⁻/Li⁺ molar | 20 | 6660 | 66.4 | 7218 | 72.0 | 8328 | 83.0 | 8514 | 84.9 |
| ratio = 1) | 40 | 7818 | 77.9 | 8202 | 81.8 | 8658 | 86.3 | 9318 | 92.9 |
| 300 RPM, Reflux | 60 | 8346 | 83.2 | 8538 | 85.1 | 9192 | 91.6 | 9408 | 93.8 |
| | 120 | 8772 | 87.5 | 9006 | 89.8 | 9354 | 93.3 | 9552 | 95.2 |
| | 180 | 9108 | 90.8 | 9252 | 92.2 | 9522 | 94.9 | 9630 | 96.0 |
| | 240 | 9168 | 91.4 | 9414 | 93.9 | 9570 | 95.4 | 9612 | 95.8 |
| | 360 | 9144 | 91.2 | 9456 | 94.3 | 9588 | 95.6 | 9636 | 96.1 |
| | 480 | 9234 | 92.1 | 9444 | 94.2 | 9594 | 95.7 | 9606 | 95.8 |
| | 720 | 9216 | 91.9 | 9438 | 94.1 | 9606 | 95.8 | 9624 | 96.0 |

As a result of the experiment, it was observed that at reaction temperatures of 25° C. and 40° C., the reaction reached equilibrium under conditions of approximately 4 hours, and as the reaction temperature increased to 80° C., the time required to reach equilibrium decreased, confirming that equilibrium was reached within approximately 1 hour.

$$Target Lithium Concentration ( \frac{mg}{L} , ppm ) = \frac{\begin{matrix}Lithium content ( mass , mg ) \\ contained in the input lithium carbonate\end{matrix}}{\begin{matrix}Volume of solution ( {H}_{2} O ) , L ) used \\ in the prearation of lithium carbonate slurry\end{matrix}} \qquad [ Equation 1 ]$$

The target lithium concentration refers to the value representing the amount of lithium contained in the input lithium carbonate relative to the volume of solution used in the preparation of the lithium carbonate slurry. This corresponds to the expected lithium concentration assuming that the hydroxylation reaction of lithium carbonate (Li₂CO₃) proceeds with a 100% conversion rate, as shown in Equation 1.

$$Recovery Rate ( \% ) = \frac{\begin{matrix}Mass of lithium carbonate contained \\ in the converted solution\end{matrix}}{\begin{matrix}Mass of lithium carbonate contained \\ in the input lithium carbonate\end{matrix}} \times 100 \qquad [ Equation 2 ]$$

The recovery rate refers to the value representing the amount of lithium contained in the converted solution relative to the amount of lithium contained in the input lithium carbonate.

According to Equation 1, the target lithium concentration is 10,030 ppm (mg/L). Based on the recovery rate (%) calculated according to Equation 2, it was observed that the recovery rate reached approximately 92% at 25° C., and increased to approximately 96% as the reaction temperature increased to 80° C.

Accordingly, when the target lithium concentration is approximately 10,000 to 12,000 ppm, it was confirmed that an increase in the reaction temperature reduces the time required to reach reaction equilibrium and increases the recovery rate.

### Experimental Example 2: Lithium Concentration and Recovery Rate in the Filtrate After Hydroxylation According to Solid-to-Liquid Ratio and OH⁻/Li⁺ Molar Ratio in Lithium Carbonate (Li₂CO₃) Slurry Solution

The lithium concentration and recovery rate in the filtrate after the hydroxylation reaction were measured according to the solid-to-liquid ratio and OH⁻/Li⁺ molar ratio in the lithium carbonate (Li₂CO₃) slurry.

First, in the case of the lithium carbonate (Li₂CO₃) slurry, the solid (lithium carbonate, g) to liquid (H₂O, L) ratio was adjusted within the range of 6 to 100. Calcium hydroxide (Ca(OH)₂) powder was added under conditions in which the OH⁻/Li⁺ molar ratio was set to 1, 1.25, 1.5, and 2, and the hydroxylation reaction was carried out at 25° C. for 24 hours under stirring.

Second, the volume of the slurry solution used in the reaction was fixed at 50 mL. After preparing the lithium carbonate (Li₂CO₃) slurry, calcium hydroxide (Ca(OH)₂) powder was added, and the reaction was carried out using a magnetic bar at a stirring speed of 300 RPM.

Table 2 shows the reaction efficiency according to the solid-to-liquid ratio of lithium carbonate (Li₂CO₃) slurry at an OH⁻/Li⁺ molar ratio of 1.

TABLE 2
Li₂CO₃ + Ca(OH)₂ (OH⁻/Li⁺ molar ratio = 1)

| Lithium | | | | | |
|---|---|---|---|---|---|
| carbonate | | | | | |
| Solid- | Lithium | Initial | Final | Lithium | |
| to-Liquid | carbonate | Lithium | Lithium | Recovery | Calcium |
| Ratio | Weight | Concentration | Concentration | Rate | Concentration |
| (g/L) | (g) | (ppm) | (ppm) | (%) | (ppm) |
| 6 | 0.3 | 1019.575 | 864.830 | 77.888 | N.D. |
| 12 | 0.6 | 1973.151 | 1812.065 | 81.599 | N.D. |
| 15 | 0.75 | 2034.176 | 2273.662 | 81.908 | N.D. |
| 18 | 0.9 | 2058.468 | 2727.915 | 81.893 | N.D. |
| 21 | 1.05 | 2069.975 | 3180.550 | 81.842 | N.D. |
| 24 | 1.2 | 2028.305 | 3519.956 | 79.253 | N.D. |
| 27 | 1.35 | 2039.641 | 4010.906 | 80.273 | N.D. |
| 30 | 1.5 | 2069.756 | 4481.312 | 80.719 | N.D. |
| 40 | 2 | 2091.352 | 5999.266 | 81.046 | N.D. |
| 50 | 2.5 | 2040.809 | 7271.564 | 78.587 | 13.289 |
| 60 | 3 | 2063.418 | 8479.219 | 76.365 | 20.573 |
| 70 | 3.5 | 2078.109 | 9158.939 | 70.703 | 27.290 |
| 80 | 4 | 2078.767 | 9254.027 | 62.507 | 28.448 |
| 90 | 4.5 | 2040.141 | 9381.477 | 56.327 | 29.437 |
| 100 | 5 | 2014.772 | 9340.539 | 50.473 | 29.198 |

Table 3 shows the reaction efficiency according to the solid-to-liquid ratio of lithium carbonate (Li₂CO₃) slurry at an OH⁻/Li⁺ molar ratio of 1.25.

TABLE 3
Li₂CO₃ + Ca(OH)₂ (OH⁻/Li⁺ molar ratio = 1.25)

| Lithium | | | | |
|---|---|---|---|---|
| carbonate | | | | |
| Solid- | Lithium | Final | Lithium | |
| to-Liquid | carbonate | Lithium | Recovery | Calcium |
| Ratio | Weight | Concentration | Rate | Concentration |
| (g/L) | (g) | (ppm) | (%) | (ppm) |
| 6 | 0.3 | 1030.673 | 92.824 | 138.058 |
| 12 | 0.6 | 1966.759 | 88.565 | 91.629 |
| 15 | 0.75 | 2496.349 | 89.930 | 106.234 |
| 18 | 0.9 | 3018.808 | 90.626 | 65.626 |
| 21 | 1.05 | 3573.277 | 91.947 | 57.082 |
| 24 | 1.2 | 4055.681 | 91.315 | 54.315 |
| 27 | 1.35 | 4519.117 | 90.444 | 49.360 |
| 30 | 1.5 | 4826.652 | 86.939 | 67.366 |
| 40 | 2 | 6561.849 | 88.646 | 47.538 |
| 50 | 2.5 | 8012.666 | 86.596 | 33.497 |
| 60 | 3 | 9516.111 | 85.704 | 29.705 |
| 70 | 3.5 | 10634.896 | 82.097 | 31.031 |
| 80 | 4 | 10726.790 | 72.455 | 66.537 |
| 90 | 4.5 | 10512.920 | 63.121 | 28.529 |
| 100 | 5 | 10862.498 | 58.698 | 28.907 |

Table 4 shows the reaction efficiency according to the solid-to-liquid ratio of lithium carbonate (Li₂CO₃) slurry at an OH⁻/Li⁺ molar ratio of 1.5.

TABLE 4
Li₂CO₃ + Ca(OH)₂ (OH⁻/Li⁺ molar ratio = 1.5)

| Lithium | | | | |
|---|---|---|---|---|
| carbonate | | | | |
| Solid- | Lithium | Final | Lithium | |
| to-Liquid | carbonate | Lithium | Recovery | Calcium |
| Ratio | Weight | Concentration | Rate | Concentration |
| (g/L) | (g) | (ppm) | (%) | (ppm) |
| 6 | 0.3 | 1002.375 | 90.275 | 151.264 |
| 12 | 0.6 | 2023.868 | 91.136 | 3.358 |
| 15 | 0.75 | 2462.319 | 88.704 | 3.752 |
| 18 | 0.9 | 3008.460 | 90.316 | 3.522 |
| 21 | 1.05 | 3582.026 | 92.172 | 3.643 |
| 24 | 1.2 | 4045.866 | 91.094 | 3.637 |
| 27 | 1.35 | 4747.797 | 95.021 | 4.589 |
| 30 | 1.5 | 5237.709 | 94.343 | 4.433 |
| 40 | 2 | 7050.715 | 95.250 | 5.943 |
| 50 | 2.5 | 8349.260 | 90.234 | 7.884 |
| 60 | 3 | 10014.553 | 90.193 | 14.731 |
| 70 | 3.5 | 10426.542 | 80.488 | 18.633 |
| 80 | 4 | 10488.785 | 70.848 | 19.130 |
| 90 | 4.5 | 10513.434 | 63.124 | 19.528 |
| 100 | 5 | 10665.897 | 57.635 | 20.079 |

Table 5 shows the reaction efficiency according to the solid-to-liquid ratio of lithium carbonate (Li₂CO₃) slurry at an OH⁻/Li⁺ molar ratio of 2.

TABLE 5
Li₂CO₃ + Ca(OH)₂ (OH⁻/Li⁺ molar ratio = 2)

| Lithium | | | | |
|---|---|---|---|---|
| carbonate | | | | |
| Solid- | Lithium | Final | Lithium | |
| to-Liquid | carbonate | Lithium | Recovery | Calcium |
| Ratio | Weight | Concentration | Rate | Concentration |
| (g/L) | (g) | (ppm) | (%) | (ppm) |
| 6 | 0.3 | 1126.851 | 99.949 | 177.264 |
| 12 | 0.6 | 2193.905 | 98.793 | 87.409 |
| 15 | 0.75 | 2533.262 | 91.260 | 73.163 |
| 18 | 0.9 | 3035.076 | 91.115 | 62.767 |
| 21 | 1.05 | 3486.579 | 89.716 | 56.192 |
| 24 | 1.2 | 3944.827 | 88.819 | 48.577 |
| 27 | 1.35 | 4409.067 | 88.242 | 45.210 |
| 30 | 1.5 | 4864.827 | 87.627 | 41.673 |
| 40 | 2 | 6395.923 | 86.404 | 34.914 |
| 50 | 2.5 | 8114.785 | 87.700 | 33.022 |
| 60 | 3 | 9552.672 | 86.033 | 29.999 |
| 70 | 3.5 | 10866.409 | 83.884 | 27.532 |
| 80 | 4 | 10962.590 | 74.048 | 29.929 |
| 90 | 4.5 | 10970.464 | 65.868 | 28.445 |
| 100 | 5 | 10988.194 | 59.377 | 28.459 |

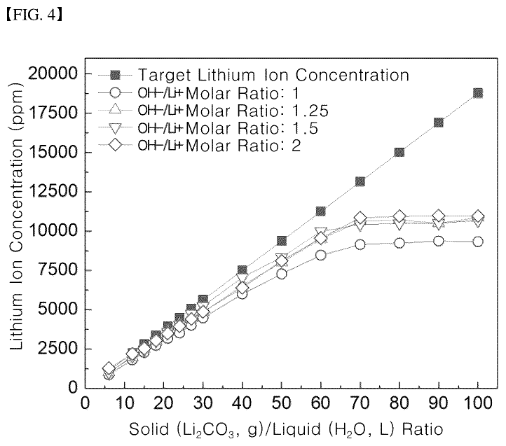

According to the experimental results, it was confirmed that the final lithium ion concentration in the filtrate increased as the solid-to-liquid ratio of the lithium carbonate (Li₂CO₃) slurry solution increased (see FIG. 4).

In addition, it was confirmed that the final lithium ion concentration in the filtrate increased as the OH⁻/Li⁺ molar ratio of the lithium carbonate (Li₂CO₃) slurry solution increased (see FIG. 4).

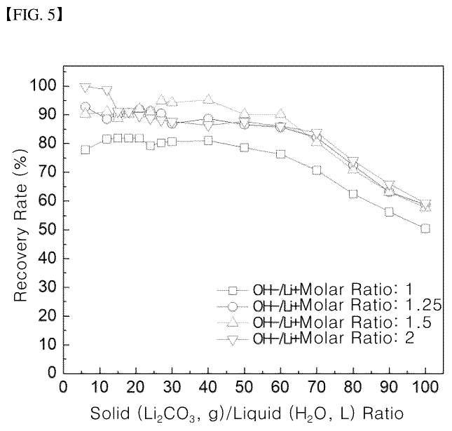

Furthermore, it was confirmed that the lithium ion recovery rate in the filtrate increased as the OH⁻/Li⁺ molar ratio of the lithium carbonate (Li₂CO₃) slurry solution increased (see FIG. 5).

Moreover, under the condition where the solid-to-liquid ratio of the lithium carbonate (Li₂CO₃) slurry solution was 100 g/L and the OH⁻/Li⁺ molar ratio was 2, the maximum lithium concentration was confirmed to be 10,988.194 ppm, and the corresponding lithium ion recovery rate was confirmed to be 59.377% (see Table 5).

Accordingly, it was confirmed that increasing either the solid-to-liquid ratio or the OH⁻/Li⁺ molar ratio of the lithium carbonate (Li₂CO₃) slurry solution does not lead to an increase in the maximum lithium concentration beyond approximately 12,000 ppm (see FIG. 4).

In addition, it was confirmed that the lithium ion recovery rate in the filtrate decreased as the solid-to-liquid ratio of the lithium carbonate (Li₂CO₃) slurry solution increased (see FIG. 5).

Furthermore, it was confirmed that the recovery rate sharply decreased when the solid-to-liquid ratio exceeded 60 g/L compared to the target concentration (see FIG. 5).

### Experimental Example 3: Hydroxylation Reaction Rate and Lithium Recovery Rate of Lithium Carbonate According to Reaction Temperature (Target Lithium Concentration: 20,060 ppm)

The lithium ion concentration and recovery rate in the filtrate after the hydroxylation reaction were evaluated at reaction temperatures of 40° C., 60° C., and 80° C. and reaction times ranging from 0 to 1,440 minutes, under the conditions of a solid-to-liquid ratio of 108.4 g/L and an OH⁻/Li⁺ molar ratio of 2 in the lithium carbonate (Li₂CO₃) slurry solution.

Table 6 shows the distribution of lithium and calcium ion concentrations in the filtrate and the lithium recovery rate after the hydroxylation reaction of lithium carbonate (Li₂CO₃), under the condition that the solid-to-liquid ratio of the lithium carbonate (Li₂CO₃) slurry solution is 108.4 g/L and the reaction temperature is 40° C.

TABLE 6
Li₂CO₃ + Ca(OH)₂_Temperature (40° C.)

| Lithium | | | | |
|---|---|---|---|---|
| carbonate | | | | |
| Solid- | | Final | Lithium | |
| to-Liquid | Reaction | Lithium | Recovery | Calcium |
| Ratio | Time | Concentration | Rate | Concentration |
| (g/L) | (min) | (ppm) | (%) | (ppm) |
| 108.4 g/1 L | 10 | 8829.25 | 44.01 | 33.96 |
| | 20 | 8940.35 | 44.57 | 32.38 |
| | 40 | 9447.82 | 47.10 | 36.96 |
| | 60 | 9629.77 | 48.00 | 31.46 |
| | 120 | 10026.18 | 49.98 | 29.47 |
| | 180 | 9965.87 | 49.68 | 28.94 |
| | 240 | 10250.06 | 51.10 | 29.93 |
| | 360 | 10234.48 | 51.02 | 32.03 |
| | 480 | 10611.45 | 52.90 | 27.72 |
| | 1440 | 10964.24 | 54.66 | 26.37 |

Table 7 shows the distribution of lithium and calcium ion concentrations in the filtrate and the lithium recovery rate after the hydroxylation reaction of lithium carbonate (Li₂CO₃), under the condition that the solid-to-liquid ratio of the lithium carbonate (Li₂CO₃) slurry solution is 108.4 g/L and the reaction temperature is 60° C.

TABLE 7
Li₂CO₃ + Ca(OH)₂_Temerature (60° C.)

| Lithium | | | | |
|---|---|---|---|---|
| carbonate | | | | |
| Solid- | | Final | Lithium | |
| to-Liquid | Reaction | Lithium | Recovery | Calcium |
| Ratio | Time | Concentration | Rate | Concentration |
| (g/L) | (min) | (ppm) | (%) | (ppm) |
| 108.4 g/1 L | 10 | 8720.62 | 43.47 | 33.30 |
| | 20 | 8941.60 | 44.57 | 31.25 |
| | 40 | 9315.31 | 46.44 | 31.42 |
| | 60 | 9491.63 | 47.32 | 29.12 |
| | 120 | 9695.58 | 48.33 | 27.59 |
| | 180 | 9867.01 | 49.19 | 28.17 |
| | 240 | 10429.00 | 51.99 | 34.23 |
| | 360 | 10497.66 | 52.33 | 29.51 |
| | 480 | 10637.40 | 53.03 | 27.78 |
| | 1440 | 11135.41 | 55.51 | 26.54 |

Table 8 shows the distribution of lithium and calcium ion concentrations in the filtrate and the lithium recovery rate after the hydroxylation reaction of lithium carbonate (Li₂CO₃), under the condition that the solid-to-liquid ratio of the lithium carbonate (Li₂CO₃) slurry solution is 108.4 g/L and the reaction temperature is 80° C.

TABLE 8
Li₂CO₃ + Ca(OH)₂_Temperature (80° C.)

| Lithium | | | | |
|---|---|---|---|---|
| carbonate | | | | |
| Solid- | | Final | Lithium | |
| to-Liquid | Reaction | Lithium | Recovery | Calcium |
| Ratio | Time | Concentration | Rate | Concentration |
| (g/L) | (min) | (ppm) | (%) | (ppm) |
| 108.4 g/1 L | 10 | 8773.99 | 43.74 | 30.80 |
| | 20 | 9138.81 | 45.56 | 27.73 |
| | 40 | 9458.66 | 47.15 | 30.05 |
| | 60 | 9592.63 | 47.82 | 27.39 |
| | 120 | 9767.95 | 48.69 | 27.25 |
| | 180 | 10034.22 | 50.02 | 26.52 |
| | 240 | 10029.38 | 50.00 | 29.70 |
| | 360 | 10234.38 | 51.02 | 27.79 |
| | 480 | 10299.31 | 51.34 | 29.31 |
| | 1440 | 10438.15 | 52.03 | 30.65 |

According to the experimental results, it was confirmed that equilibrium was reached within 4 hours at all temperatures in the range of 40° C., 60° C., and 80° C.

In addition, the highest lithium ion concentration observed after the completion of the hydroxylation reaction was approximately 11,135 ppm at 60° C.

Furthermore, in an attempt to increase the lithium ion concentration in the mixture, when the solid-to-liquid ratio of the lithium carbonate (Li₂CO₃) Slurry solution was set to 100 g/L or higher and the OH⁻/Li⁺ molar ratio was increased to 2 or higher, it was found that stirring was not effectively performed due to the viscosity of the slurry. As a result, the lithium recovery rate remained below 60%, and the high moisture content of the sludge during the separation of the lithium solution caused a significant loss in solution recovery.

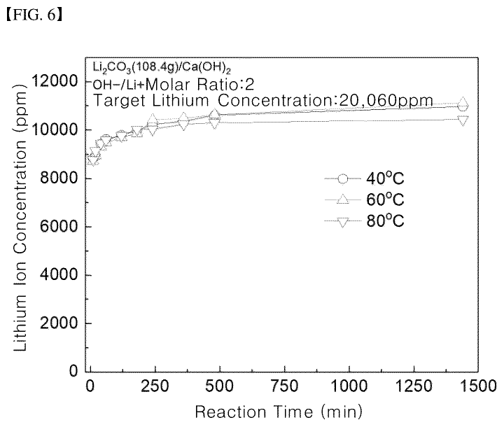

Accordingly, when the target lithium concentration is approximately 20,000 ppm, it was confirmed that increasing the reaction temperature does not effectively increase the maximum lithium concentration beyond approximately 12,000 ppm (see FIG. 6).

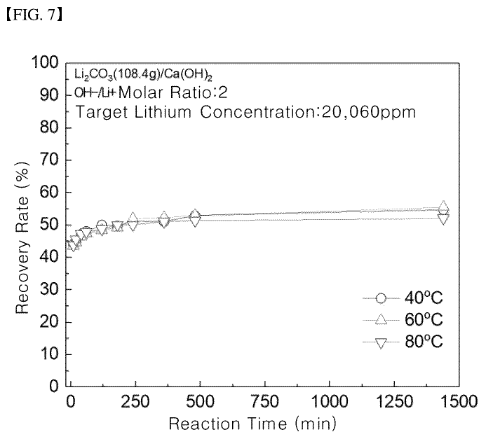

Additionally, when the target lithium concentration is approximately 20,000 ppm, it was confirmed that increasing the reaction temperature does not effectively improve the lithium ion recovery rate in the mixture (see FIG. 7).

### Experimental Example 4: Lithium Ion (Li⁺) Concentration and Recovery Rate in Filtrate According to the Solid-to-Liquid Ratio of Lithium Carbonate (Li₂CO₃) Slurry Solution Using a Homogenizer

In order to evaluate the conversion efficiency of the hydroxylation reaction of lithium carbonate (Li₂CO₃) under different stirring conditions, a lab-scale homogenizer was used to analyze the lithium ion concentration in the filtrate after the reaction, according to the solid-to-liquid ratio of the lithium carbonate (Li₂CO₃) slurry.

As the reaction condition, the OH⁻/Li⁺ molar ratio was set to 1.2, and the solid-to-liquid ratio of the 50 mL lithium carbonate (Li₂CO₃) slurry was adjusted in the range of 27 to 108 g/L. The stirring speed was maintained at 7,000 RPM, and the reaction was carried out at 25° C. for 4 hours.

The lithium ion concentration in the filtrate was analyzed relative to the target lithium ion concentration, and the hydroxylation reaction recovery rate was evaluated accordingly.

Table 9 shows the concentrations of lithium and calcium ions in the filtrate recovered after the hydroxylation reaction according to the solid-to-liquid ratio of the lithium carbonate (Li₂CO₃) slurry using a homogenizer.

TABLE 9
Li₂CO₃ + Ca(OH)₂_{_{—}}Slurry Homogenizer

| | Lithium | | | | | | | |
|---|---|---|---|---|---|---|---|---|
| | Carbonate | | | | Final | Target | | |
| | Solid-to- | Reaction | | | Lithium | Lithium | Lithium | Calcium |
| | Liquid | Temper- | Stirring | Reaction | Concen- | Concen- | Recovery | Concen- |
| | Ratio | ature | Speed | Time | tration | tration | Rate | tration |
| Conditions | (g/L) | (° C.) | (RPM) | (hr) | (ppm) | (ppm) | (%) | (ppm) |
| Li₂CO₃ + Ca(OH)₂ | 27 | 25° C. | 7000 | 4 | 4986.65 | 4996.58 | 99.80 | N.D. |
| OH⁻/Li⁺ Molar | 54 | | | | 9269.63 | 9993.16 | 92.76 | 23.92 |
| Ratio: 1.2 | 81 | | | | 10249.15 | 14989.75 | 68.37 | 25.20 |
| | 108 | | | | 10727.08 | 19986.33 | 53.67 | 26.69 |

According to Table 9, under the condition where the target lithium concentration was set to 9,993.16 ppm, the reaction was carried out at 25° C. with an OH⁻/Li⁺ molar ratio of 1.2 and a solid-to-liquid ratio of the lithium carbonate (Li₂CO₃) slurry adjusted to 54 g/L. Using a homogenizer, the maximum lithium ion concentration achieved was 9,269.63 ppm, the lithium recovery rate was 92.76%, and the calcium concentration was 23.92 ppm.

Additionally, when the target lithium concentration was set to 19,986 ppm under the same temperature (25° C.) and OH⁻/Li⁺ molar ratio (1.2), and the solid-to-liquid ratio of the lithium carbonate (Li₂CO₃) slurry was increased to 108 g/L, the maximum lithium ion concentration achieved using a homogenizer was 10,727.08 ppm, with a lithium recovery rate of 53.67% and a calcium concentration of 26.69 ppm.

According to Table 3, when the target lithium concentration was set to 9,252.9 ppm, the reaction was conducted at 25° C. with an OH⁻/Li⁺ molar ratio of 1.25 and a solid-to-liquid ratio of the lithium carbonate (Li₂CO₃) of 50 g/L using a magnetic bar for stirring. The maximum lithium ion concentration achieved was 8,012.666 ppm, the lithium recovery rate was 86.596%, and the calcium concentration was 33.497 ppm.

Furthermore, when the target lithium concentration was set to 18,505.8 ppm under the same temperature (25° C.), with an OH⁻/Li⁺ molar ratio of 1.25 and a solid-to-liquid ratio of the lithium carbonate (Li₂CO₃) of 100 g/L, and the reaction was stirred using a magnetic bar, the maximum lithium ion concentration achieved was 10,862.498 ppm, with a lithium recovery rate of 58.6987% and a calcium concentration of 28.907 ppm.

Accordingly, when the target lithium concentration is in the range of 10,000 to 12,000 ppm, adjusting the solid-to-liquid ratio of the lithium carbonate slurry and applying a homogenizer for stirring slightly increases the lithium ion recovery rate compared to using a magnetic bar.

However, when the target lithium concentration is approximately 20,000 ppm, it was confirmed that the difference in lithium ion recovery rates after the hydroxylation reaction is minimal between the use of a homogenizer and a magnetic bar for stirring.

### Experimental Example 5: Lithium Ion Concentration and Recovery Rate in Filtrate After Repeated Hydroxylation Reactions Using a Homogenizer

First, a first hydroxylation reaction is performed such that the solid-to-liquid ratio of the lithium carbonate (Li₂CO₃) slurry reaches 27 g/L, and the first filtrate is then separated.

Second, a mixture of lithium carbonate (Li₂CO₃) and calcium hydroxide (with an OH⁻/Li⁺ molar ratio of 1.2) is added to the first filtrate to adjust the solid-to-liquid ratio to 27 g/L. A second hydroxylation reaction is then performed by stirring for 4 hours using either a mechanical stirrer (300 RPM) or a homogenizer (7,000 RPM), and the second filtrate is separated.

Third, a mixture of lithium carbonate (Li₂CO₃) and calcium hydroxide (with an OH⁻/Li⁺ molar ratio of 1.2) is added to the second filtrate to adjust the solid-to-liquid ratio to 27 g/L. A third hydroxylation reaction is then performed by stirring for 4 hours using either a mechanical stirrer (300 RPM) or a homogenizer (7,000 RPM), and the third filtrate is separated.

Fourth, a mixture of lithium carbonate (Li₂CO₃) and calcium hydroxide (with an OH⁻/Li⁺ molar ratio of 1.2) is added to the third filtrate to adjust the solid-to-liquid ratio to 27 g/L. A fourth hydroxylation reaction is then performed by stirring for 4 hours using either a mechanical stirrer (300 RPM) or a homogenizer (7,000 RPM), and the fourth filtrate is separated.

Fifth, the lithium ion concentration and lithium recovery rate in the first through fourth filtrates were analyzed.

Table 10 shows the lithium concentration in the recovered lithium solution and the hydroxylation reaction recovery rate after repeated hydroxylation reactions of lithium carbonate slurry stirred using a mechanical stirrer.

TABLE 10
Li₂CO₃ + Ca(OH)₂_{_{—}} stirred using mechanical stirrer - by the number of repetitions

| | | | | Final | | | |
|---|---|---|---|---|---|---|---|
| | | | | Lithium | Maximum | | Final |
| | Amount | | | Ion | Lithium | Lithium | Calcium |
| Solid-to- | of Ca | Stirring | Number | Concen- | Concen- | Recovery | Concen- |
| Liquid Ratio | Added | Speed | of | tration | tration | Rate | tration |
| (g/L) | (g) | (RPM) | Repetitions | (ppm) | (ppm) | (%) | (ppm) |
| 27 | 34.20 | 300 | 1 | 4546.73 | 4996.58 | 91.00 | N.D. |
| 27 | 34.20 | | 2 | 8857.62 | 9543.31 | 92.81 | 11.64 |
| 27 | 34.20 | | 3 | 9603.73 | 13854.20 | 69.32 | 21.33 |

Table 11 shows the lithium concentration in the recovered lithium solution and the hydroxylation reaction recovery rate after repeated hydroxylation reactions of lithium carbonate slurry stirred using a homogenizer.

TABLE 11
Li₂CO₃ + Ca(OH)₂_{_{—}}stirred using Homogenizer _by the number of repetitions

| | | | | Final | | | |
|---|---|---|---|---|---|---|---|
| | | | | Lithium | Maximum | | Final |
| Solid-to- | Amount | | | Ion | Lithium | Lithium | Calcium |
| Liquid | of Ca | Stirring | Number | Concen- | Concen- | Recovery | Concen- |
| Ratio | Added | Speed | of | tration | tration | Rate | tration |
| (g/L) | (g) | (RPM) | Repetitions | (ppm) | (ppm) | (%) | (ppm) |
| 27 | 34.20 | 7000 | 1 | 4757.44 | 4996.58 | 95.21 | 21.76 |
| 27 | 34.20 | | 2 | 9194.91 | 9754.02 | 94.27 | 25.29 |
| 27 | 34.20 | | 3 | 10656.27 | 14191.50 | 75.09 | 30.93 |
| 27 | 34.20 | | 4 | 11778.34 | 15652.85 | 75.25 | 32.57 |

Based on Tables 11 and 12, it can be confirmed that the concentration of lithium ions in the filtrate increases as the number of hydroxylation reaction cycles increases. In addition, it was confirmed that the final lithium ion concentration and the lithium recovery rate were higher when stirring was performed using a homogenizer, compared to when a mechanical stirrer was used.

According to Table 9, in the hydroxylation reaction conducted for 4 hours at a solid-to-liquid ratio of 108 g/L using a homogenizer (7,000 RPM), the final lithium concentration after the reaction was observed to be 10,727.08 ppm, and the lithium recovery rate was observed to be 53.67%.

According to Table 11, in the hydroxylation reaction conducted for 4 hours at a solid-to-liquid ratio of 27 g/L using a homogenizer (7,000 RPM), followed by four repeated hydroxylation reactions where a lithium carbonate (Li₂CO₃) and calcium hydroxide mixture (with an OH⁻/Li⁺ molar ratio of 1.2) was added each time to adjust the solid-to-liquid ratio of the filtrate back to 27 g/L, the final lithium ion concentration after the reaction was observed to be 11,778.34 ppm, and the lithium recovery rate was 75.25%.

Therefore, based on Tables 9 and 11, it was observed that under the same stirring conditions, when lithium carbonate (Li₂CO₃) was added in smaller amounts and the hydroxylation reaction was repeated multiple times, the final lithium ion concentration increased slightly.

However, even when lithium carbonate (Li₂CO₃) was divided into smaller quantities and the hydroxylation reaction was repeated, it was confirmed that when the target lithium concentration was approximately 15,000 ppm, the final lithium ion concentration and the lithium recovery rate still remained below approximately 80%.

### Experimental Example 6: Lithium Ion Concentration in Filtrate After Additional Washing of Sludge Generated from the Hydroxylation Reaction

During the separation process of the filtrate from the mixture, a volume loss (less than 30 vol %) of the recovered lithium hydroxide (LiOH) solution occurs due to the moisture content in the calcium carbonate (CaCO₃) cake formed. Therefore, in order to improve the recovery rate of the lithium hydroxide (LiOH) solution, an additional washing step was performed on the formed calcium carbonate (CaCO₃) cake to separate the lithium hydroxide (LiOH) solution.

First, a lithium carbonate (Li₂CO₃) slurry with a solid-to-liquid ratio of 54 g/L (Li₂CO₃-53.7 g/H₂O-1000 mL) and an OH⁻/Li⁺ molar ratio of 1.1 was prepared, and calcium hydroxide (Ca(OH)₂) was added to the slurry. The mixture was reacted at 20° C. for 12 hours to conduct the hydroxylation reaction. After the reaction, the formed sludge (calcium carbonate, unreacted Li₂CO₃, Ca(OH)₂) was separated from the lithium hydroxide (LiOH) solution.

Second, 1,000 mL of water was added to the separated sludge, and washing was performed using a mechanical stirrer for 1 hour. After washing, the filtrate was separated.

Third, the washing procedure was repeated twice.

Fourth, the lithium ion concentration and calcium ion concentration in the recovered solution were measured according to the number of washing cycles.

Table 12 shows the lithium and calcium ion concentrations in the recovered solution according to the number of washing cycles performed on the sludge generated from the hydroxylation reaction.

TABLE 12
Li₂CO₃ + Ca(OH)₂ (Solid-to-liquid ratio: 54 g/L, OH⁻/Li⁺ molar ratio: 1.1)

| | | | | | Amount of | Amount of | Final | | Final |
|---|---|---|---|---|---|---|---|---|---|
| | Water | Reaction | | | Lithium | Calcium | Lithium Ion | Lithium | Calcium |
| | Added | Time | Stirring | OH⁻/Li⁺ | Carbonate | Hydroxide | Concentration | Recovery | Concentration |
| | (mL) | (20° C.) | Speed (RPM) | Molar Ratio | Added (g) | Added (g) | (ppm) | Rate (%) | (ppm) |
| Raw | 1000 | 12 hours | 300 | 1.1 | 53.770 | 61.800 | 9597.20 | 95.11 | 22.12 |
| 1^{st} Washing | 1000 | 1 hour | 300 | | | | 1468.86 | | 78.30 |
| 2^{nd} Washing | 1000 | 1 hour | 300 | | | | 219.97 | | 36.93 |

According to Table 12, the lithium concentration in the recovered solution from the hydroxylation reaction was confirmed to be 9,597.2 ppm, and the calcium concentration was confirmed to be 22.12 ppm. The lithium concentration in the recovered solution from the first washing of the sludge was 1,468.86 ppm, and that from the second washing was 219.97 ppm, indicating that the lithium concentration decreased as the number of sludge washing cycles increased.

Therefore, it is considered that the uncollected residual lithium hydroxide (LiOH) component remaining in the sludge generated after the hydroxylation reaction of lithium carbonate (Li₂CO₃) can be recovered as a solution through additional washing of the sludge, and that the recovered solution may be reused as an aqueous solution for the preparation of subsequent lithium carbonate (Li₂CO₃) slurry.

### Experimental Example 7: Lithium Ion Concentration and Recovery Rate in Filtrate After Hydroxylation Reaction According to Initial Lithium Ion Concentration

As confirmed in Experimental Example 6, it was observed that additional recovery of residual lithium hydroxide (LiOH) solution from the sludge generated after the hydroxylation reaction of lithium carbonate (Li₂CO₃) is possible. Therefore, in this example, the recovered solution is circulated and reused as an aqueous medium for preparing a subsequent lithium carbonate (Li₂CO₃) slurry, and the lithium recovery efficiency after the hydroxylation reaction is evaluated according to the target lithium concentration.

First, lithium hydroxide (LiOH) solutions were prepared such that the initial lithium ion concentration ranged from approximately 1,000 to 5,000 ppm.

Second, to achieve target lithium concentrations of approximately 10,000 ppm and 15,000 ppm, a mixture of lithium carbonate and calcium hydroxide was added to the solution under conditions where the OH⁻/Li⁺ molar ratio was 1, and the hydroxylation reaction was conducted at 25° C. for 4 hours.

Table 13 shows the distribution of lithium and calcium contents in the filtrate after the reaction, according to the initial lithium ion concentration in the lithium hydroxide (LiOH) solution, when the target lithium concentration was approximately 10,000 ppm.

TABLE 13
LiOH sol. + (Li₂CO₃ + Ca(OH)₂)

| | Reaction | | | | | | | | |
|---|---|---|---|---|---|---|---|---|---|
| | Time | | | | | Initial | Final | Lithium | Final |
| Volume | (Room | Stirring | OH⁻/Li⁺ | Li₂CO₃ | Ca(OH)₂ | Lithium Ion | Lithium Ion | Recovery | Calcium |
| (mL) | Temperature) | Speed (RPM) | Molar Ratio | Added (g) | Added (g) | Conc. (ppm) | Conc. (ppm) | Rate (%) | Conc. (ppm) |
| 50 | 4 | 300 | 1 | 2.431 | 2.528 | 1097.33 | 10058.79 | 99.64 | 19.30 |
| 50 | 4 | 300 | 1 | 2.161 | 2.247 | 2140.59 | 10119.73 | 99.81 | 20.00 |
| 50 | 4 | 300 | 1 | 1.891 | 1.966 | 3169.75 | 10130.89 | 99.63 | 21.05 |
| 50 | 4 | 300 | 1 | 1.621 | 1.685 | 4121.04 | 10112.60 | 99.92 | 28.33 |
| 50 | 4 | 300 | 1 | 1.351 | 1.404 | 5119.43 | 10108.81 | 99.89 | 33.12 |

Table 14 shows the distribution of lithium and calcium contents in the filtrate after the reaction, depending on the initial lithium ion concentration in the lithium hydroxide (LiOH) solution, when the target lithium concentration is approximately 15,000 ppm.

TABLE 14
LiOH sol. + (Li₂CO₃ + Ca(OH)₂)

| | Reaction | | | | | | | | |
|---|---|---|---|---|---|---|---|---|---|
| | Time | | | | | Initial | Final | Lithium | Final |
| Volume | (Room | Stirring | OH⁻/Li⁺ | Li₂CO₃ | Ca(OH)₂ | Lithium Ion | Lithium Ion | Recovery | Calcium |
| (mL) | Temperature) | Speed (RPM) | Molar Ratio | Added (g) | Added (g) | Conc. (ppm) | Conc. (ppm) | Rate (%) | Conc. (ppm) |
| 100 | 4 | 300 | 1 | 7.565 | 7.865 | 1042.13 | 10299.70 | 68.47 | 27.67 |
| 100 | 4 | 300 | 1 | 7.025 | 7.303 | 2086.49 | 10386.23 | 68.85 | 29.28 |
| 100 | 4 | 300 | 1 | 6.484 | 6.741 | 3060.20 | 10481.34 | 69.60 | 28.48 |
| 100 | 4 | 300 | 1 | 5.944 | 6.180 | 4032.69 | 10667.46 | 70.96 | 44.19 |
| 100 | 4 | 300 | 1 | 5.404 | 5.618 | 5034.08 | 10366.36 | 68.95 | 45.89 |

Referring to Table 13, when the target lithium concentration is approximately 10,000 ppm and the initial lithium ion concentration in the lithium hydroxide solution is approximately 1,000 to 5,000 ppm, a lithium recovery rate of approximately 99% is observed.

Accordingly, it can be confirmed that the washing solution obtained from the sludge of Example 6 can be effectively reused as the aqueous solution for preparing a subsequent lithium carbonate (Li₂CO₃) slurry targeting a lithium concentration of approximately 10,000 ppm, with a high lithium recovery rate of about 99%.

Referring to Table 14, when the target lithium concentration is approximately 15,000 ppm and the initial lithium ion concentration is approximately 1,000 to 5,000 ppm, a lithium recovery rate of approximately 70% is observed.

Accordingly, it can be confirmed that the washing solution obtained from the sludge of Example 6 may not be suitable for reuse as the aqueous solution for preparing a subsequent lithium carbonate (Li₂CO₃) slurry targeting a lithium concentration of approximately 15,000 ppm, due to the relatively low lithium recovery rate.

### Experimental Example 8: Separation and Concentration of Lithium Ions Contained in the Washing Solution of Sludge Discharged from Hydroxide Reaction Applying Electric Adsorption Process

It is considered that, through additional washing of the sludge generated after the hydroxide reaction of lithium carbonate (Li₂CO₃) in Experimental Example 6, the uncollected residual lithium hydroxide (LiOH) component can be recovered into a solution and used as an aqueous solution for the preparation of a subsequent lithium carbonate (Li₂CO₃) slurry.

Furthermore, as confirmed in Experimental Example 7, using the washing solution of the sludge as the aqueous solution for the preparation of a subsequent lithium carbonate (Li₂CO₃) slurry targeting a lithium concentration of approximately 10,000 ppm is expected to result in a high lithium recovery rate.

However, as a large amount of water is required to achieve a high lithium recovery rate, an improvement was sought by recovering low-concentration lithium ions with a final lithium concentration of less than approximately 1,000 ppm, to convert the low-concentration lithium ions into an aqueous solution with a lithium concentration of approximately 3,000 ppm or higher, by applying a low-energy concentration technology such as electric adsorption technology.

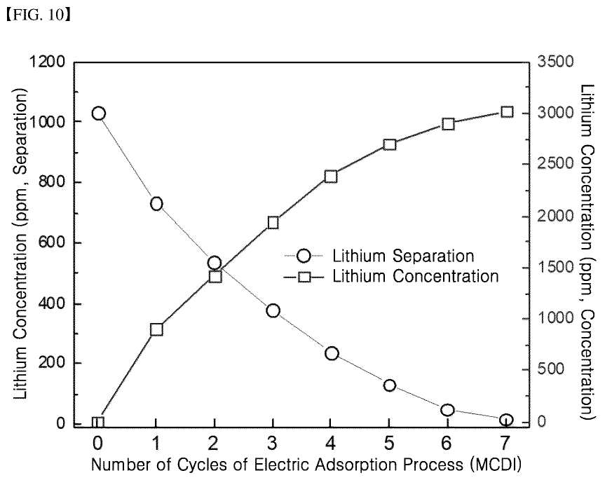

FIG. 10 illustrates that, by applying an electric adsorption technology, namely MCDI (Membrane Capacitive Deionization), to a lithium hydroxide solution with a lithium ion concentration of approximately 1,032 ppm, lithium ions can be separated and concentrated from the lithium hydroxide solution, enabling conversion into an aqueous solution with a lithium ion concentration of approximately 3,022 ppm.

First, the electric adsorption module applied for the separation and concentration of lithium ions employed electrodes composed of conductive activated carbon, and the module was assembled using 200 unit cells, each consisting of a (+) electrode/anion exchange membrane/spacer/cation exchange membrane/(−) electrode.

Second, the operating potential applied for the adsorption and concentration of lithium ions was ±1.3V for each electrode.

Third, 10 L of a lithium hydroxide (LiOH) aqueous solution with a lithium ion concentration of approximately 1,032 ppm was circulated through the electric adsorption module for 5 minutes at a flow rate of 2 L/min to adsorb lithium ions.

Fourth, after adsorbing lithium ions onto the electric adsorption module, air flushing was performed to remove the solvent while maintaining the pre-desorption potential at 1.3 V.

Fifth, after solvent removal, desorption was conducted by applying a reverse potential of −1.3 V using 1 liter of distilled water as the desorption solution for 8 minutes, thereby separating and concentrating the lithium ions.

Sixth, the desorption solution used in the above electric adsorption process was reused repeatedly to perform the electric adsorption and desorption cycles.

Seventh, the lithium ion concentrations in the lithium hydroxide aqueous solution and in the desorption solution were measured after repeating the electric adsorption process.

After seven repetitions of the electric adsorption process, it was confirmed that lithium ions were almost completely removed from the lithium hydroxide aqueous solution with a lithium ion concentration of approximately 1,032 ppm, and that the lithium ion concentration in the desorption solution reached approximately 3,000 ppm.

Therefore, it was confirmed that the solution obtained by washing the sludge can be concentrated using the electric adsorption process and subsequently used as an aqueous solution for preparing lithium carbonate (Li₂CO₃) slurry.

In addition, this process significantly reduces the amount of wastewater (low-concentration lithium solution) generated during the hydroxide reaction, and mitigates the environmental burden during discharge by lowering the strong alkalinity of the waste calcium carbonate sludge.

### Example 9: Compositional Analysis of the Crystallization Products According to the Crystallization Conditions of the Hydroxide Reaction Filtrate

In this experiment, the composition of the final product was analyzed according to the crystallization conditions (temperature) of the lithium hydroxide (LiOH) solution, which was prepared via a hydroxide reaction from lithium carbonate (Li₂CO₃).

The lithium hydroxide (LiOH) solution used in the crystallization reaction was prepared by reacting a Li₂CO₃/Ca(OH)₂ slurry at 25° C. under conditions with a solid-to-liquid ratio of 60 and an OH⁻/Li⁺ molar ratio of 1.5. The lithium ion concentration in the resulting filtrate was approximately 10,014 ppm.

FIGS. 11 to 13 show the X-ray diffraction (XRD) patterns of the products obtained at different crystallization temperatures under a vacuum condition of 37 mbar.

For the lithium hydroxide (LiOH) powder recovered at crystallization temperatures above 50° C., the anhydrous phase of LiOH was observed. In contrast, at temperatures of 40° C. or lower, the resulting product was identified as lithium hydroxide (LiOH) monohydrate.

### Example 10: Separation of Impurities Contained in the Filtrate After the Hydroxide Reaction

Following the hydroxide reaction of lithium carbonate (Li₂CO₃), it was confirmed that a portion of calcium remained in the filtrate due to the solubility of the formed calcium carbonate (CaCO₃) and unreacted calcium hydroxide (Ca(OH)₂). This experiment aimed to control the relative content of calcium ions (Ca²⁺) in the filtrate in order to enhance the lithium hydroxide (LiOH) content after crystallization.

Changes in the concentrations of lithium and calcium in the filtrate were analyzed according to the concentration ratio of the lithium hydroxide (LiOH) solution.

First, a Li₂CO₃/Ca(OH)₂ slurry (solid-liquid ratio of lithium carbonate (Li₂CO₃): 54.2 g/L, OH⁻/Li⁺ molar ratio: 1) was reacted at 25° C. for 24 hours, and the resulting lithium hydroxide (LiOH) filtrate was separated. At this point, the lithium concentration in the LiOH solution was confirmed to be approximately 9,200 ppm, while the calcium concentration was approximately 17.4 ppm.

Second, 100 mL of the LiOH filtrate was used in a concentration experiment conducted at 80° C. under a vacuum pressure of 37 mbar. When the solution volume was reduced to approximately 63 mL, 54 mL, and 34 mL, the precipitated lithium hydroxide (LiOH) and calcium carbonate (CaCO₃) were filtered and removed from the filtrate.

Third, the concentrations of lithium ions (Li⁺) and calcium ions (Ca²⁺) in the filtrate were measured after each concentration stage.

As a result of the concentration analysis, the lithium ion (Li⁺) concentration increased in line with the theoretical predictions, while the calcium ion (Ca²⁺) concentration increased at a relatively lower rate than predicted. When the volume of the LiOH solution was reduced to approximately 34 mL, the concentrations of lithium and calcium in the filtrate were approximately 27,784.6 ppm and approximately 30.5 ppm, respectively.

These results suggest that removing calcium precipitates during the filtrate concentration process can improve the purity of the resulting lithium hydroxide powder.

In the above, exemplary embodiments of the high-efficiency method for producing lithium hydroxide from lithium carbonate through process improvement according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

### INDUSTRIAL APPLICABILITY

The high-efficiency method for producing lithium hydroxide from lithium carbonate according to the present disclosure has the effect of improving the recovery rate of lithium hydroxide.

The high-efficiency method for producing lithium hydroxide from lithium carbonate according to the present disclosure has the effect of reducing the calcium ion concentration in the final product.

The high-efficiency method for producing lithium hydroxide from lithium carbonate according to the present disclosure has the effect of enabling the recycling of waste sludge and wastewater generated by the reaction between lithium carbonate and calcium hydroxide.

The high-efficiency method for producing lithium hydroxide from lithium carbonate according to the present disclosure has the effect of reducing the amount of wastewater generated in the process by recycling steam generated during the production of lithium hydroxide from lithium carbonate.

1. A method for producing lithium hydroxide, comprising:
(a) preparing a mixture by adding calcium hydroxide (Ca(OH)₂) to a lithium carbonate (Li₂CO₃) slurry;
(b) separating a filtrate from the mixture prepared in step (a);
(c) concentrating by evaporating water of the filtrate separated in step (b); and
(d) crystallizing lithium hydroxide (LiOH) from the filtrate concentrated in step (c).

2. The method of claim 1,
wherein in step (a), the lithium carbonate slurry is prepared by mixing lithium carbonate (Li₂CO₃) with an aqueous solution at a solid-to-liquid ratio of 40 to 80 (g/L), and
wherein in step (a), a molar ratio of hydroxide ions (OH⁻) to lithium ions (Li⁺) in the mixture ranges from 1:1 to 1.5:1.

3. The method of claim 2,
wherein step (a) is performed at a temperature of 20° C. to 100° C. for at least 1 hour.

4. The method of claim 1, further comprising:
(b-1) subjecting sludge remaining after the separation of the filtrate in step (b) to water washing with stirring;
(b-2) separating a solution obtained after the water washing of the sludge in step (b-1) and preparing a concentrated lithium ion aqueous solution through an electric adsorption process; and
(b-3) feeding the concentrated lithium ion aqueous solution obtained in step (b-2) into the mixture of step (a).

5. The method of claim 4,
wherein the electric adsorption process is a membrane capacitive deionization (MCDI) process.

6. The method of claim 4,
wherein the electric adsorption process of step (b-2) is repeated.

7. The method of claim 4,
wherein a desalted solution generated through the electric adsorption process is fed into the water washing of the sludge for use.

8. The method of claim 1,
wherein when a calcium compound is precipitated through the concentration of step (c), the precipitated calcium compound is removed from the filtrate to increase purity of lithium hydroxide (LiOH).

9. The method of claim 1,
wherein when lithium hydroxide and a calcium compound are precipitated through the concentration of step (c), the calcium compound is removed from a solution of the lithium hydroxide and the calcium compound that are precipitated, and an aqueous solution of the lithium hydroxide is fed into the mixture of step (a).

10. The method of claim 1,
wherein the crystallization of lithium hydroxide (LiOH) performed in step (d) is carried out by evaporating the filtrate.

11. The method of claim 10,
wherein the crystallization of lithium hydroxide (LiOH) performed in step (d) is carried out at a pressure of 20 to 50 mbar and at a temperature of 40° C. or lower.

12. The method of claim 10,
wherein the crystallization of lithium hydroxide (LiOH) performed in step (d) is carried out at a pressure of 20 to 50 mbar and at a temperature of 50° C. or higher.

13. The method of claim 10,
wherein a solution obtained by condensing steam generated by the evaporation of step (d) is fed into the water washing of the sludge for use.
